(19) United States
(12) Patent Application Publication
(10) Pub. No.: US 2024/0355143 A1
(43) Pub. Date: Oct. 24, 2024

(54) METHOD FOR SUPPORTING MOTION RECOGNITION FOR ROBOT, COMPUTING DEVICE SUPPORTING THE SAME, AND SYSTEM SUPPORTING THE SAME

(71) Applicants: Hyundai Motor Company, Seoul (KR); Kia Corporation, Seoul (KR)

(72) Inventor: So Hee Kim, Suwon-Si (KR)

(21) Appl. No.: 18/242,786

(22) Filed: Sep. 6, 2023

(30) Foreign Application Priority Data
Apr. 18, 2023 (KR) 10-2023-0050821

(51) Int. Cl. G06V 40/20; B25J 9/16; G06V 10/82; G06V 40/10

(52) U.S. Cl. CPC G06V 40/23; B25J 9/1697; G06V 10/82; G06V 40/10

(57) ABSTRACT

Disclosed is a computing device, which includes memory configured to store an image composed of a plurality of a plurality of frames where a person is captured as a subject, and a processor operatively connected with the memory. The processor may be configured to: determine a plurality of joints corresponding to the image; determine joint data; generate a virtual joint image comprising coordinate values; and store the generated virtual joint image in the memory. The joint data may include: joint prediction values for predicting whether the plurality of joints correspond to any of a plurality of known joints of the person, and joint location values corresponding to locations of the plurality of joints corresponding to the joint prediction values.

### CROSS-REFERENCE TO RELATED APPLICATION

This application claims the benefit of priority to Korean Patent Application No. 10-2023-0050821, filed in the Korean Intellectual Property Office on Apr. 18, 2023, the entire contents of which are incorporated herein by reference.

### TECHNICAL FIELD

The present disclosure relates to robot operation, and more particularly, processing for motion recognition of humans.

### BACKGROUND

In general, robots have been developed for industry use and are playing a greater role in factory automation. Recently, more industries are adopting robots, such as medical robots, aerospace robots, or the like, and home robots designed for use in ordinary residential homes have also been produced.

Meanwhile, research has been actively conducted on active services of the robots such that the robots are introduced into an environment, such as a production environment, which is difficult for humans to perform work to replace the persons. To this end, there is a growing interest in motion recognition of a person such that action or motion of the robot appropriately follows the action or motion of the person and mutually applying motion recognition information to robot control.

A conventional process of recognizing motion of the person utilizes the entire image in which a person is captured. Such a manner may deal with the details of the motion recognition of the person. However, because the amount of information needed to be processed tends to be large, the need for computing resources and processing time may also increase.

### SUMMARY

The present disclosure has been made to solve the above-mentioned problems occurring in the prior art while advantages achieved by the prior art are maintained intact.

According to the present disclosure, a method for supporting motion recognition for a robot to assist in generating a virtual joint image associated with more efficient motion recognition based on joint location information and a joint prediction value and process a motion recognition result according to it to be applicable to a robot, a computing device supporting the same, and a system supporting the same.

Herein, the technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a computing device may include: memory configured to store an image composed of a plurality of frames where a person is captured as a subject; and a processor operatively connected with the memory. The processor may be configured to: determine a plurality of joints corresponding to the image; determine joint data including: joint prediction values for predicting whether the plurality of joints correspond to any of a plurality of known joints of the person, and joint location values corresponding to locations of the plurality of joints; generate, based on the joint data, a virtual joint image including coordinate values that correspond to the joint location values; and store the generated virtual joint image in the memory. The coordinate values, in the virtual joint image, may be divided into a plurality of channels.

The memory may store a joint generation learning model provided to determine the plurality of joints corresponding to the image. The processor may be further configured to: apply the joint generation learning model to the image to determine, based on the plurality of frames, the plurality of joints; and determine the joint data based on the plurality of joints.

The processor may be further configured to: determine, based on the plurality of joints, a plurality of axial coordinate values for the plurality of joints in each of the plurality of frames and the joint prediction values corresponding to the plurality of axial coordinate values.

The processor may be further configured to: obtain, based on the plurality of frames, the plurality of axial coordinate values and the joint prediction values; accumulate the obtained coordinate values and the joint prediction values to generate a representative value; and generate the virtual joint image based on the representative value.

The processor may be configured to generate the virtual joint image by: dividing the joint location values and the joint prediction values based on a location for each body part of the person; and arranging the divided joint location values and joint prediction values at different locations on a data arrangement diagram.

The processor may be configured to generate the virtual joint image by: dividing the joint location values and the joint prediction values into at least one of: an upper body portion and a lower body portion of the person, or a left body portion and a right body portion of the person with respect to a center line of the person.

The processor may be further configured to: recognize a motion of the person on the image based on the virtual joint image; map a result of recognizing the motion with the image; and store the mapped result in the memory.

The computing device may further include at least one of: a communication interface configured to receive the image from an external electronic device; a camera device configured to capture the image of the person as the subject; or a display configured to output the virtual joint image.

According to one or more example embodiments, a method may include: obtaining, by a processor of a computing device, an image including a plurality of frames, in which a person is captured as a subject; determining, by the processor, a plurality of joints corresponding to the image; determining, by the processor, joint data including: joint prediction values for predicting whether the plurality of joints correspond to any of a plurality of known joints of the person, and joint location values corresponding to locations of the plurality of joints; generating, by the processor and based on the joint data, a virtual joint image including coordinate values that correspond to the joint location values; and storing, by the processor, the generated virtual joint image in memory of the computing device. The coordinate values, in the virtual joint image, may be divided into a plurality of channels

Determining the plurality of joints may include: applying a joint generation learning model, previously stored in the memory, to the image to determine, based on the plurality of frames, the plurality of joints.

Determining the joint data may include: determining, by the processor and based on the plurality of joints, a plurality of axial coordinate values for the plurality of joints in each of the plurality of frames and the joint prediction values corresponding to the plurality of axial coordinate values.

Generating the virtual joint image may include: obtaining, by the processor and based on the plurality of frames, the plurality of axial coordinate values and the joint prediction values; accumulating, by the processor, the obtained coordinate values and the joint prediction values to generate a representative value; and generating the virtual joint image based on the representative value.

Generating the virtual joint image may further include: dividing, by the processor, the joint location values and the joint prediction values based on a location for each body part of the person; and arranging, by the processor, the divided joint locations values and joint prediction values at different locations on a data arrangement diagram.

Generating the virtual joint image may include: dividing, by the processor, the joint location values and the joint prediction values into at least one of: an upper body portion and a lower body portion of the person, or a left body portion and a right body portion of the person with respect to a center line of the person.

The method may further include: recognizing, by the processor, a motion of the person on the image based on the virtual joint image; mapping a result of recognizing the motion with the image; and storing the mapped result in the memory.

According to one or more example embodiments of the present disclosure, a system may include: a robot; an input data providing device configured to provide an image including a plurality of frames where a person is captured as a subject; and a computing device. The robot may be configured to receive, from the computing device, a result of determining the motion. The computing device may include: a communication interface configured to receive the image; memory configured to store the image; and a processor operatively connected with the communication interface and the memory. The processor may be configured to: apply a joint generation learning model, previously stored in the memory, to the image to determine a plurality of joints of the person; determine joint data including: joint prediction values for predicting whether the plurality of joints correspond to any of a plurality of known joints of the person, and joint location values corresponding to locations of the plurality of joints; generate, based on the joint data, a virtual joint image including coordinate values that correspond to the joint location values; recognize a motion of the person on the image based on the generated virtual joint image; and provide a result of recognizing the motion to the robot. The coordinate values, in the virtual joint image, may be divided into a plurality of channels.

Furthermore, the system may include a computing storage medium included in the above-mentioned computing device or a computing storage medium including at least one instruction configured to perform the above-mentioned method for supporting the motion recognition for the robot.

At least a portion of the present disclosure may be a method for generating a virtual joint image for motion recognition, which may include at least some of a method using a predicted value of a joint, a method for arranging joints depending on meanings, a method for arranging the joints depending on a location (an upper body, a lower body, the left, or the right) of the body part, or a method for generating joints corresponding to all frames as one image. Thus, the present disclosure may be understood as the concept of integrating all drawings described below. Furthermore, some embodiments described in the respective drawings may be understood as the present disclosure including, for example, a method for generating the virtual joint image. Thus, the specification may be described and understood to include the present disclosure corresponding to generating, storing, and providing a virtual joint image for supporting a method and system for robot motion recognition.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating an example of a configuration of a motion recognition system for performing motion recognition of a person for a robot;

FIG. 2 is a drawing illustrating an example of a configuration of a computing device;

FIG. 3 is a drawing illustrating an example of a motion recognition method through generation of a virtual joint image;

FIG. 4 is a drawing illustrating an example of a joint object generated by a joint generation network;

FIG. 5 is a drawing illustrating an example of an information output screen associated with a virtual joint image corresponding to one frame;

FIG. 6 is a drawing illustrating another example of an information output screen associated with a virtual joint image corresponding to one frame;

FIG. 7 is a drawing illustrating an example of an x-coordinate channel in a virtual joint image corresponding to the entire image corresponding to t frames;

FIG. 8 is a drawing illustrating an example of an x-coordinate channel in a virtual joint image corresponding to the entire image corresponding to 16 frames;

FIG. 9 is a drawing illustrating an example of the result of dividing two reference values for an x-coordinate channel in a virtual joint image corresponding to the entire image corresponding to t frames;

FIG. 10 is a drawing illustrating an example of the result of dividing four reference values for an x-coordinate channel in a virtual joint image corresponding to the entire image corresponding to t frames;

FIG. 11 is a drawing illustrating an example of a method for generating a virtual joint image in a motion recognition method; and

FIG. 12 is a block diagram illustrating a computing system.

### DETAILED DESCRIPTION

Hereinafter, one or more example embodiments of the present disclosure will be described in detail with reference to the accompanying drawings. In adding the reference numerals to the components of each drawing, it should be noted that the identical component is designated by the identical numerals even when they are displayed on other drawings. Further, in describing the one or more example embodiment of the present disclosure, a detailed description of well-known features or functions will be ruled out in order not to unnecessarily obscure the gist of the present disclosure.

In describing the components of the one or more example embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

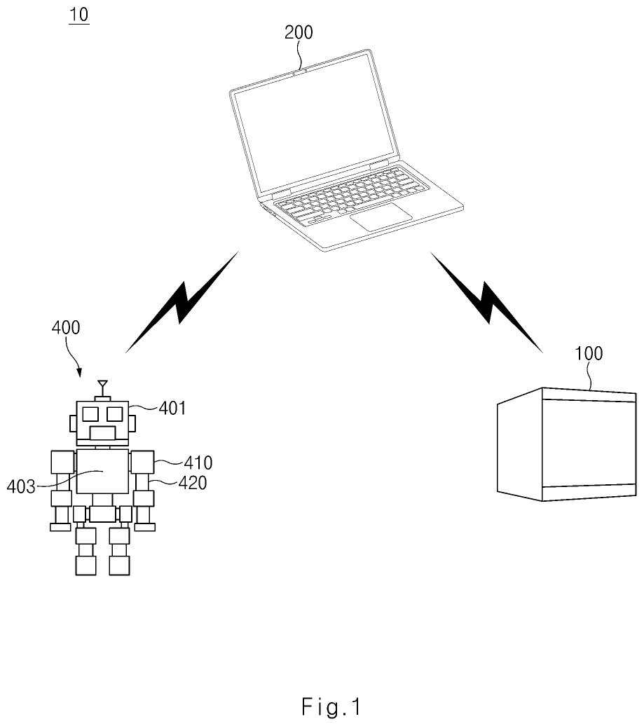

Hereinafter, one or more example embodiments of the present disclosure will be described in detail with reference to FIGS. 1 to 12.

FIG. 1 is a drawing illustrating an example of a configuration of a motion recognition system for performing motion recognition of a person for a robot.

Referring to FIG. 1, a motion recognition system 10 may include an input data providing device 100, a computing device 200, and a robot 400.

The input data providing device 100 may include at least one electronic device capable of performing at least one of collecting, storing, processing, or delivering input data for motion recognition of a person. For example, the input data providing device 100 may store and manage an image composed of at least one frame in which motion or action of the person is captured (e.g., a moving image including a plurality of frames or a still image composed of one frame). In this regard, the input data providing device 100 may include a communication circuit capable of establishing a communication channel with an external electronic device (e.g., a server device, a user terminal, or a black box capable of providing an image for motion recognition), a storage device capable of storing an image received from the external electronic device, and at least one processor for providing the stored image depending on the request of the computing device 200 or providing the stored image to the computing device 200 at a certain period. The at least one processor of the input data providing device 100 may detect an image meeting a predetermined certain reference (e.g., an image including a certain part or more of the body of the person or an image where the body of the person is displayed above a certain rate in a scene) among the at least one image stored in the storage device and may provide the detected image to the computing device 200 when the detected image is greater than or equal to a predetermined certain number or when the amount of data of the detected image is greater than or equal to a certain size. As another example, the input data providing device 100 may include a camera device electrically or operatively connected with the computing device 200. The input data providing device 100 may control at least one camera in response to the request of the computing device 200 to capture an image for a subject (e.g., at least one person) disposed in a specific direction and may provide the captured image to the computing device 200. As described above, when the input data providing device 100 is implemented as a camera device, it may be provided as one component of the computing device 200 or may be integrated with the computing device 200.

The computing device 200 may receive at least one image to be analyzed for motion recognition of the person from the input data providing device 100. Herein, the computing device 200 may include a camera device. When the computing device 200 is configured to operate the camera device and collect an image for motion recognition of the person, the configuration of the input data providing device 100 may be omitted from the motion recognition system 10. Alternatively, when the computing device 200 is configured to communicate with an external electronic device (e.g., a server device or a user terminal capable of collecting and providing an image) which receives an image for motion recognition of the person using a communication interface (or a communication circuit), the configuration of the input data providing device 100 may be omitted from the motion recognition system 10.

The computing device 200 may calculate joint data (e.g., a joint location value or a joint prediction value) for an image received through a joint generation network (or at least one of a joint generation learning model for generating a joint through an image, artificial-intelligence (AI) for generating a joint through an image, or a neural network for generating a joint). For example, when the joint generation network specifies a specific joint extracted from the image, the joint prediction value may include a probability that the specified specific joint (e.g., a known joint in a human person) will be correctly specified on the image. As an example, when the joint generation network specifies a shoulder joint on the image, the joint prediction value may be a probability that the joint in the image portion will be the shoulder joint. The joint generation network may include, for example, OpenPose, HRNet, or the like.

The computing device 200 may generate a virtual joint image based on the joint location value and the joint prediction value. The virtual joint image may include an image where joint location values and joint prediction values of a plurality of frames are arranged on an axis of at least one of a time or a space. The virtual joint image may include, for example, a 3D (x, y, joint prediction value) or 4D (x, y, z, joint prediction value) image. The computing device 200 may output the virtual joint image through a specified output device (e.g., a display). The computing device 200 may provide a virtual joint image to be output according to a predetermined condition or a user input in various forms. For example, the computing device 200 may differently arrange joints for each part (e.g., an upper body, a lower body, the left, or the right) of the body, in generating the virtual joint image. The computing device 200 may apply a predetermined learning model (e.g., a 2-dimensions convolutional neural network (2D CNN)) to at least one virtual joint image to process motion recognition. As described above, the computing device 200 of the present disclosure may generate a virtual joint image using a location of a joint extracted from the image and a predicted value (or an expected value) of the joint, may arrange a joint according to a part of the body of the person, and may identify a correlation between joints using a lightweight artificial intelligence learning model to perform motion recognition.

The robot 400 may be configured to follow or precede a specified motion pattern based on applying the result of recognizing the motion of the person and joint data associated with the motion recognition. In this regard, the robot 400 may include a plurality of bodies (e.g., a head part 401 and a chest part 403), robot joints 410 arranged in certain areas of the plurality of bodies, and at least one robot link 420 which connects between the plurality of robot joints 410 or is connected with a specific joint. As compared with the body of the person, the robot 400 may include the head part 401 and the chest part 403 and may include a neck joint for connecting between the head part 401 and the chest part 403, shoulder joints formed at upper left and right sides of the chest part 403, upper arms of left and right arms respectively connected with the shoulder joints, elbow joints arranged at ends of the upper arms of the left and right arms, lower arms of the left and right arms respectively connected with the elbow joints, left and right wrist joints arranged at ends of the lower arms of the left and right arms, left and right hands connected with the wrist joints, pelvic joints formed at lower left and right sides, left and right thighs connected with the pelvic joints, left and right knee joints connected with ends of the thighs, left and right calves connected with ends of the knee joints, ankle joints arranged at ends of the calves, and left and right feet connected with ends of the ankle joints. As described above, the robot 400 may perform a specific motion pattern based on the plurality of robot joints 410 of the robot 400 and the robot links 420 which connects the robot joints 410 or are connected with ends of the robot joints 410. As an example, the robot 400 may receive joint data (e.g., a joint location value and a joint prediction value) ensured through an image analysis in real time from the computing device 200 and may move a joint corresponding to the received joint data to correspond to the joint location, thus following a motion pattern output on the image.

Meanwhile, the computing device 200 may communicate with the robot 400 to collect information about the number of joints and the number of links from the robot 400 and may limit an image analysis in a motion recognition process based on the number of the joints and the number of the links, which are collected. For example, the computing device 200 may perform a join and link analysis in the body of the person included in the image on the basis of the number of the joints of the robot 400 and the number of the links of the robot 400.

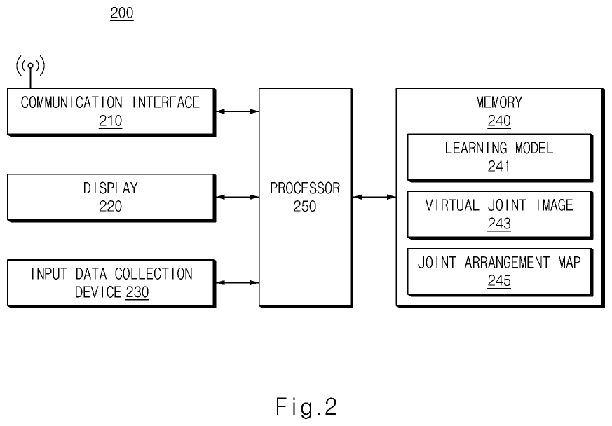

FIG. 2 is a drawing illustrating an example of a configuration of a computing device.

Referring to FIGS. 1 and 2, a computing device 200 of the present disclosure may include a communication interface 210, a display 220, an input data collection device 230, a memory 240 (or storage), and a processor 250 (or at least one processor).

The communication interface 210 may support a communication function of the computing device 200. For example, the communication interface 210 may include at least one wired communication interface capable of supporting a wired communication channel of the computing device 200 and may establish a wired communication channel with at least one of a robot 400 or an input data providing device 100. Alternatively, the communication interface 210 may include at least one wireless communication interface capable of supporting a wireless communication channel of the computing device 200 and may establish a wireless communication channel with at least one of the robot 400 or the input data providing device 100. As an example, the communication interface 210 may establish a communication channel (e.g., at least one of a wired communication channel or a wireless communication channel) with the input data providing device 100 and may receive input data (e.g., an image capable of performing motion recognition of a person) from the input data providing device 100.

Alternatively, the communication interface 210 may transmit a message for requesting the input data providing device 100 to provide input data in response to control of the processor 250 and may receive at least one image from the input data providing device 100. Meanwhile, the communication interface 210 may provide the robot 400 with at least a portion of the motion recognition result in response to control of the processor 250 and may receive feedback information according to motion of the robot 400 from the robot 400.

The display 220 may output at least one screen associated with operating the computing device 200. Such a display 220 is described as one component of the computing device 200, but the present disclosure is not limited thereto. The display 220 may be configured as a separate electronic device independent of the computing device 200. In this case, the display 220 may receive display data from the computing device 200 through the communication interface 210 and may output the received display data. The display 220 may output a screen corresponding to at least one process included in a motion recognition process in response to the operation of the processor 250. As an example, the display 220 may output at least one of a screen corresponding to at least one image provided by the input data providing device 100, a joint generation screen calculated by applying the at least one image to a joint generation network, a joint data (e.g., joint location value or joint prediction value) display screen of generated joints, at least one virtual joint image generated based on the joint data, an arrangement screen of joints for each body part depending on specified at least one criterion, or a screen for displaying a motion recognition result corresponding to the result of identifying a correlation between joints using a lightweight artificial intelligence learning model.

When the computing device 200 is configured to directly collect an image to be provided to a joint generation network, the input data collection device 230 may be included in the computing device 200. Thus, when a motion recognition system 10 is configured to receive input data (e.g., at least one image) from the input data providing device 100, the configuration of the input data collection device 230 may be omitted from the computing device 200. The input data collection device 230 may include, for example, at least one camera device (or camera sensor). The input data collection device 230 may collect an image for a subject (e.g., a person) of a predetermined certain size and shape. The input data collection device 230 may temporarily or semi-permanently store the collected input data in the memory 240.

The memory 240 may store and manage data or a program necessary for driving of the computing device 200. As an example, the memory 240 may include at least one of a learning model 241, a virtual joint image 243, or a joint arrangement map 245.

The learning model 241 may include at least one model applied to the generation of the joint and the performance of the motion recognition according to the present disclosure. For example, the learning model 241 may include a learning model for joint generation and a learning model for motion recognition. The learning model for joint generation may include at least one of OpenPose or HRNet. The learning model for motion recognition may include at least one of ResNet or VGGNet. However, the present disclosure is not limited to the above-mentioned specific learning model. The learning model 241 may further include various other learning models capable of generating a joint through an image analysis and various other learning models capable of processing motion recognition based on a joint location value, a joint prediction value, and a joint correlation.

The virtual joint image 243 may include an image generated based on joint data corresponding to an input image (or input data) (e.g., a joint location value and a joint prediction value for at least one joint) using a joint generation network (or a joint generation model) included in the learning model 241. Alternatively, the virtual joint image 243 may include joint data including a location of each of a plurality of joints detected by applying a model to an image and a joint prediction value and an image generated based on the joint data. The virtual joint image 243 may include a joint image for each divided part of the body (e.g., at least a part of an upper body joint image, a lower body joint image, or a left body joint image or a right body joint image with respect to a center line of a face (or any center line of a person) in the body of the person).

The joint arrangement map 245 may include map information which is a criterion capable of dividing the body of the person. For example, the joint arrangement map 245 may include information about which part should be disposed on any of the body (e.g., an upper body, a lower body, or the left of the body or the right of the body with respect to a specific criterion (e.g., the center line of the face)), when the virtual joint image 243 is disposed for each part of the body with regard to a size or rate of the image.

The processor 250 may perform at least one of delivery of a signal necessary for operation of the computing device 200, processing of the signal, storage of the signal, or output or transmission of the result of processing the signal. For example, the processor 250 may perform image collection, joint generation, virtual joint image generation, and motion analysis, in conjunction with generating the virtual joint image 243 and performing motion recognition based on the virtual joint image 243.

In conjunction with the image collection, the processor 250 may perform an operation for collecting an image for generating the virtual joint image 243 depending on occurrence of a predetermined event or an input of a manager who operates the computing device 200. For example, the processor 250 may control the communication interface 210 to establish a communication channel with the input data providing device 100 and may receive at least one image necessary to generate the virtual joint image 243 (e.g., an image, including a plurality of frames, in which motion or action of the person is captured) from the input data providing device 100. Alternatively, the processor 250 may control a camera device, which is operatively or electrically connected, in response to the manager input to control image capturing about a person who performs a specific action and may collect the captured image.

In conjunction with the joint generation, the processor 250 may perform the joint generation corresponding to an image received using a joint generation network (or the learning model 241) which is previously stored in the memory 240. In this process, the processor 250 may process image filtering for a plurality of frames included in the image, object detection corresponding to the body of the person, recognition of a feature point of the detected object (e.g., parts capable of being recognized as joints or parts capable of being recognized as links connecting the joints), or arrangement or output of the recognized feature points of the object.

In conjunction with the virtual joint image generation, the processor 250 may collect joint data (e.g., a joint location value and a joint prediction value) for the generated joint. In this regard, the processor 250 may collect a pixel location value of the generated joint as the joint location value. The processor 250 may allocate a predicted value (or a name of the joint) to each joint with regard to a relative location of the joint. Alternatively, the processor 250 may compare relative reference location information capable of recognizing a predetermined person joint (e.g., name information of joints located within a certain distance from a head or a chest) with a joint generated through a current image and may allocate a joint prediction value in the current image. The processor 250 may accumulate at least some of pieces of information about the plurality of frames to fix a joint location value and a joint prediction value.

In conjunction with the motion analysis, the processor 250 may apply at least a portion of the virtual joint image 243 to the predetermined learning model 241 (e.g., a 2D CNN as a model for motion recognition) to output the result of whether the current virtual joint image 243 corresponds to any motion. The processor 250 may output the obtained result on the display 220 and may collect, store, and manage feedback information about whether the motion recognition is correctly performed through the fixing of the manager. When the feedback information above a certain number of times is accumulated, the processor 250 may automatically determine motion recognition of a specific result without the manager input process and may output the result.

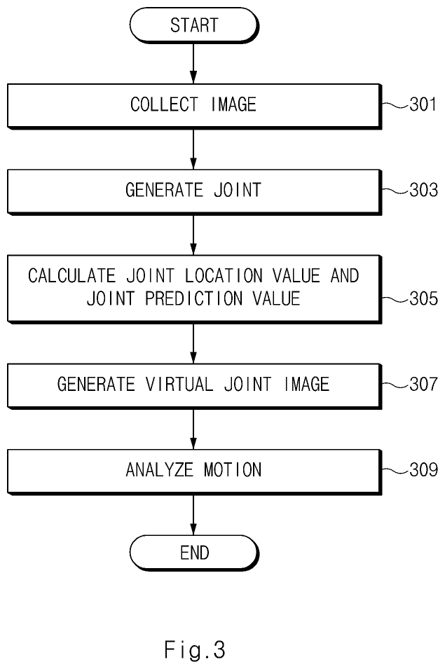

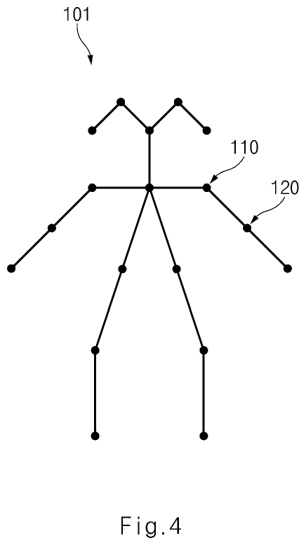

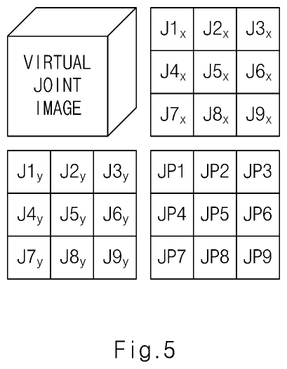

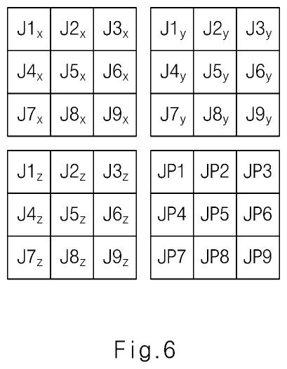

FIG. 3 is a drawing illustrating an example of a motion recognition method through generation of a virtual joint image. FIG. 4 is a drawing illustrating an example of a joint object generated by a joint generation network. FIG. 5 is a drawing illustrating an example of an information output screen associated with a virtual joint image corresponding to one frame. FIG. 6 is a drawing illustrating another example of an information output screen associated with a virtual joint image corresponding to one frame.

First of all, referring to FIGS. 1 and 3, in conjunction with the motion recognition method through the generation of the virtual joint image according to the present disclosure, in operation 301, a processor 250 of a computing device 200 may collect an image associated with joint generation. For example, the processor 250 may establish a communication channel with an external electronic device (e.g., an input data providing device 100) and may collect an image associated with joint generation from the external electronic device. Alternatively, the processor 250 may control a camera device operatively or electrically connected to control image capturing for a specific subject (e.g., a person) and may collect the captured image. The collected image may be temporarily or semi-permanently stored.

In operation 303, the processor 250 may apply the collected image to a joint generation network to generate a joint. For example, as shown in FIG. 4, the processor 250 may generate a joint object 101 including at least some of at least one body joint 110 or a joint link 120 connecting the at least one body joint 110. The joint object 101 may be information generated by applying the image collected in operation 301 to the joint generation network, which may include, for example, the plurality of body joints 110 corresponding to the body of the person and the joint links 120 connecting the plurality of body joints 110. Alternatively, the joint object 101 may exclude the plurality of joint links 120 and may include only the plurality of body joints 110. Meanwhile, FIG. 4 illustrates the joint object 101 including a plurality of joints arranged on a face location, a plurality of joints arranged on both arms, and a plurality of joints arranged on both legs, but the present disclosure is not limited thereto. For example, the joint object 101 may include less joints or more joints.

In operation 305, the processor 250 may calculate a joint location value and a joint prediction value. The joint prediction value may be a result of the joint generation network, which may be a predicted probability value of a joint corresponding to location coordinates (x, y or x, y, z) of a specific joint (e.g., a wrist or the like) in an image which is present for each frame of the image. The predicted value of the joint may include a probability that the joint generation network will guess that the joint is the specific joint (e.g., the wrist). For example, the processor 250 may calculate at least two of x, y, z-axis coordinates of joints included in the joint object 101 and may calculate a predicted value of the joint (e.g., a name of the joint). As an example, the processor 250 may calculate two coordinates (coordinates on x and y axes) where a joint of a specific name is located on a 2D image. Alternatively, the processor 250 may calculate three coordinates (coordinates on x, y, and z axes) where the joint of the specific name is located on a 3D image. Furthermore, the processor 250 may calculate a joint name of a location (or a point) where coordinates are calculated. In this regard, the processor 250 may identify a mutual relationship between joints on the basis of the joint arrangement map 245 and may allocate names of joints included in the joint object 101 based on the mutual relationship. As another example, when locations (or points) where specific joints are arranged include a plurality of pixels, the processor 250 may set an average value or a center value of the plurality of pixels or a specific point value according to a predetermined certain criterion to a representative value representing the joint location. According to the joint generation network applied in conjunction with joint generation, the processor 250 may calculate (an x-axis location coordinate, a y-axis location coordinate, a joint prediction value) or (an x-axis location coordinate, a y-axis location coordinate, a z-axis location coordinate, a joint prediction value) for each joint as a result (or joint data).

In operation 307, the processor 250 may generate a virtual joint image, based on the calculated joint data (e.g., a joint location value and a joint prediction value). The processor 250 may output the generated virtual joint image on the display 220. A screen including the virtual joint image may include the virtual joint image and channels (e.g., display panels or areas) of the virtual joint image. The channel of the virtual joint image may include a location coordinate value of each of the plurality of joints included in the virtual joint image and predicted values of the joint. As an example, the screen including the virtual joint image may be displayed like FIG. 5 or 6. Referring to FIGS. 5 and 6, a 3D virtual joint image in one frame (or a specific frame in an image including a plurality of frames) may be displayed independently of a 4D virtual joint image and each channel which belongs to the 4D virtual joint image. In FIGS. 5 and 6, J may refer to a joint location and JP may refer to a predicted value of a joint. A number written together in J and JP may refer to a specific joint's number (e.g., a neck-1, a wrist-2, or the like). Thus, a number displayed on each channel may vary with the number of joints and a name of the recognized joint. Referring to FIG. 5, in the shown drawing, JNₓ denotes the x-coordinate of the Nth joint, JN_{y} denotes the y-coordinate of the Nth joint, and JPN denotes the predicted value of the Nth joint. In FIG. 5, a virtual joint image may be disposed on a left upper channel, x-axis coordinate values of Nth joints may be arranged on a right upper channel, y-axis coordinate values of the Nth joints may be arranged on a left lower channel, and joint prediction values of the Nth joints may be arranged on a right lower channel.

Referring to FIG. 6, in the shown drawing, JNₓ denotes the x-coordinate of the Nth joint, JN_{y} denotes the y-coordinate of the Nth joint, JN_{Z} denotes the z-coordinate of the Nth joint, and JPN denotes the predicted value of the Nth joint. In FIG. 6, x-axis coordinate values of Nth joints may be arranged on a left upper channel, y-axis coordinate values of the Nth joints may be arranged on a right upper channel, z-axis coordinate values of the Nth joints may be arranged on a left lower channel, and joint prediction values of the Nth joints may be arranged on right a lower channel. Additionally or alternatively, when a manager input of the computing device 200 occurs in a state where a screen shown in FIG. 6 is output, a virtual joint image described above with reference to FIG. 5 may switch to a displayed screen or the virtual joint image may be overlaid and displayed on a screen of FIG. 6. Alternatively, a virtual joint image may be displayed on a space generated after the screen is segmented or the screen displayed in FIG. 6 is reduced.

In operation 309, the processor 250 may perform a motion analysis based on the virtual joint image. For example, the processor 250 may perform the motion recognition for the virtual joint image using a 2D convolutional neural network (CNN) and may output the result.

As described above, the present disclosure may provide a method for generating a virtual joint image using a predicted value of a joint for motion recognition of a person in a system (e.g., a robot system) requiring a lightweight network.

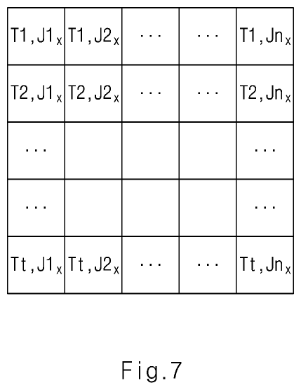

FIG. 7 is a drawing illustrating an example of an x-coordinate channel in a virtual joint image corresponding to the entire image corresponding to t frames.

Referring to FIG. 7, in conjunction with expressing an x-coordinate channel of a virtual joint image, a processor 250 of a computing device 200 may arrange each of pieces of information about x-coordinates of n joints of one frame on a lateral axis (or a horizontal axis) and may arrange each of t frames on a longitudinal axis (or a vertical axis) for x-coordinates of the respective joints. The processor 250 may express a y-coordinate channel, a z-coordinate channel, and a prediction value channel in the same manner. As an example, in conjunction with expressing the y-coordinate channel of the virtual joint image, the processor 250 may arrange each of pieces of information about x-coordinates of n joints of one frame on the lateral axis (or the horizontal axis) and may arrange each of t frames on the longitudinal axis (or the vertical axis) for y-coordinates of the respective joints. When the virtual joint image is a 4D image, in conjunction with expressing the z-coordinate channel of the virtual joint image, the processor 250 may arrange each of pieces of information about z-coordinates of n joints of one frame on the lateral axis (or the horizontal axis) and may arrange each of t frames on the longitudinal axis (or the vertical axis) for z-coordinates of the respective joints. As an example, in conjunction with expressing the joint prediction value channel of the virtual joint image, the processor 250 may arrange each of pieces of information about joint prediction values of n joints of one frame on the lateral axis (or the horizontal axis) and may arrange each of t frames on the longitudinal axis (or the vertical axis) for the joint prediction values of the respective joints. The dimension of a final virtual joint image may be (3, t, n) when the final virtual joint image is a 3D virtual joint image or may be (4, t, n) when the final virtual joint image is a 4D virtual joint image.

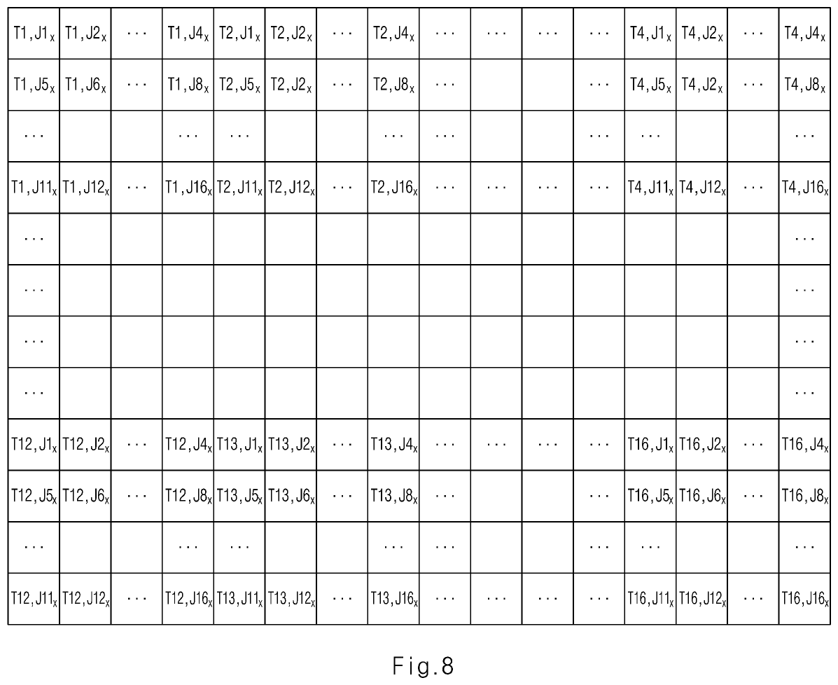

FIG. 8 is a drawing illustrating an example of an x-coordinate channel in a virtual joint image corresponding to the entire image corresponding to 16 frames.

Referring to FIGS. 7 and 8, as an example, when the number of a plurality of frames is 16, a processor 250 of a computing device 200 may arrange x-coordinate values corresponding to four frames per row. The processor 250 may arrange the x-coordinate values for the four frames per row to configure x-coordinate values for 16 joints in 16 frames in the form of a table as shown through four rows. Similarly, the processor 250 may arrange y-coordinate values, z-coordinate values, or joint prediction values for four frames per row to configure y-coordinate values, z-coordinate values, or joint prediction values for 16 joints in 16 frames in the form of a table similar to that as shown through four rows. In other words, the processor 250 may configure another channel (e.g., y and z location coordinates or a joint prediction value) of the virtual joint image as a 3D image or a 4D image in the same method as the above-mentioned method. The dimension of a final virtual joint image may be (3, t/a, a) or (4, t/a, a) (when the final virtual joint image includes a z-axis location coordinate, herein a is 4).

Meanwhile, the shown drawing exemplifies the configuration where the x-coordinate values are arranged for 16 frames and 16 joints, but the present disclosure is not limited thereto. For example, the processor 250 may configure a data sheet in the form of a rectangle similar to the shown table for a number which is less or more than the number of less frames than 16, more frames than 16, or 16 joints.

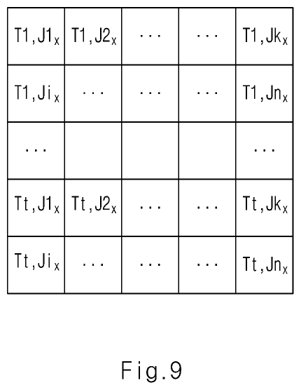

FIG. 9 is a drawing illustrating an example of the result of dividing two reference values for an x-coordinate channel in a virtual joint image corresponding to the entire image corresponding to t frames.

Referring to FIG. 9, in a process of arranging coordinate value on a specific axis for each frame, a processor 250 of a computing device 200 may provide an x-coordinate channel of a virtual joint image of the entire image having t frames, depending on a predetermined certain criterion (e.g., two reference values of an upper body and a lower body or two reference values of the left and the right of the body with respect to a center line of a face). As an example, when n joints are included in one frame, the processor 250 may separately arrange the n joints depending on predetermined two criteria (e.g., upper and lower joints or left and right joints). Referring to the drawing, among n joints, (upper or left) joints may be arranged as J1˜Jk and (lower or right) joints may be arranged as Jl˜Jn. The processor 250 may arrange joints arranged at the upper body or the left in a row on a lateral axis and may arrange lower body or right joints in a bottom row. The processor 250 may overall configure a plurality joints in a rectangular data a arrangement form while of separating the plurality of joints depending to two criteria. In this regard, k−1 and n−l may be set to the same value. As joints composed of two rows are arranged on a longitudinal axis every t frames, there may be a total of 2×t rows. The processor 250 may apply the same method to another channel of the virtual joint image (e.g., a channel corresponding to y-coordinate values, a channel corresponding to z-coordinate values, or a channel corresponding to joint prediction values) to configure a data sheet. Thus, the dimension of a final virtual joint image corresponding to a 3D image or a 4D image may be (3, t, k) or (4, t, k).

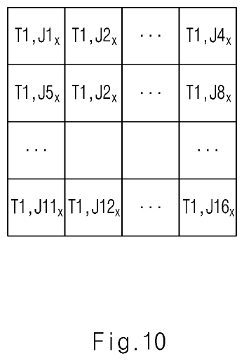

FIG. 10 is a drawing illustrating an example of the result of dividing four reference values for an x-coordinate channel in a virtual joint image corresponding to the entire image corresponding to t frames.

Referring to FIGS. 9 and 10, a processor 250 of a computing device 200 may output an x-coordinate channel of a virtual joint image of one frame image as shown. Herein, one frame may include n joints. The processor 250 may configure a data arrangement diagram (or a data sheet) where the n joints are separately arranged in four criteria (e.g., 1) a left upper body joint, 2) a right upper body joint, 3) a left lower body joint, and 4) a right lower body joint). As an example, assuming that n is 16, the processor 250 may assign four joints to an area for each part. The processor 250 may allocate J1˜J4 to the joint of the left upper body, may allocate J5˜J8 to the joint of the right upper body, may allocate J9˜J10 to the joint of the left lower body, and may allocate J11˜J16 to the joint of the right lower body, among 16 joints. The processor 250 may overall configure data arrangement in the form of a square or a rectangle.

Referring to the shown drawing, the processor 250 may arrange the left upper body joint on a lateral axis in a row, may arrange the right upper body joint in a lower row thereof on the lateral axis in a row, may arrange the left lower body joint in a lower row thereof on the lateral axis in a row, and may arrange the right lower body joint in a lower row thereof on the lateral axis in a row.

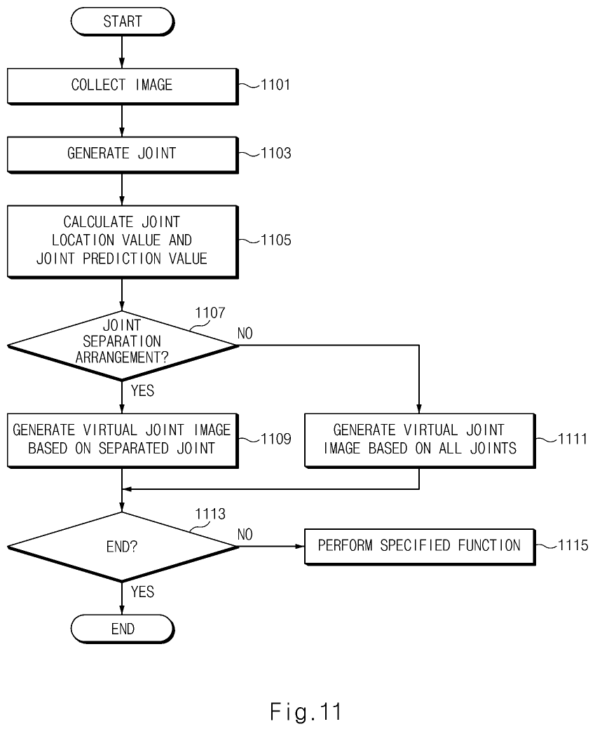

FIG. 11 is a drawing illustrating an example of a method for generating a virtual joint image in a motion recognition method.

Referring to FIG. 11, in conjunction with generating the virtual joint image in the motion recognition method, in operation 1101, a processor 250 of a computing device 200 may collect an image. In operation 1103, the processor 250 may generate a joint for each frame. In operation 1105, the processor 250 may calculate a joint location value and a joint prediction value for each frame. Operations 1101 to 1105 described above may correspond to substantially the same operations as operations 301 to 305 described above with reference to FIG. 3.

In operation 1107, the processor 250 may identify whether there is a request for joint separation arrangement. In this regard, the processor 250 may identify a setting value associated with generating the virtual joint image. When the joint separation arrangement is included in the setting value associated with generating the virtual joint image, in operation 1109, the processor 250 may generate the virtual joint image based on a separated joint. For example, the processor 250 may identify at least one criterion (e.g., a criterion for separating a joint for each body part) recorded in the setting value and may separate a joint and may generate the virtual joint image according to the separated joint as described with reference to FIGS. 9 and 10 depending to the criterion. In this process, the processor 250 may identify a joint arrangement map 245 stored in a memory 240, may separate a plurality of joints depending on a specified criterion based on the joint arrangement map 245, and may generate a virtual joint image according to the separated result. For example, the processor 250 may separate the plurality of joints into upper body joints and lower body joints and may generate a virtual joint image divided into the upper body joints and the lower body joints. The processor 250 may separate the plurality of joints into left joints of the body and right joints of the body with respect to a center line of the face and may generate a virtual joint image divided into the left joints and the right joints. Alternatively, the processor 250 may separate the plurality of joints into a lower surface separated into an upper body and a lower body and left joints of the body and right joints of the body with respect to the center line of the face for the upper body and the lower body again and may generate a virtual joint image divided into left upper joints, right upper joints, left lower joints, and right lower joints, which are separated. Meanwhile, the criterion for dividing the left of the body and the right of the body is exemplified as the center line of the face in the above-mentioned description, but the present disclosure is not limited thereto. For example, the center line of the face may change to a center line of the top of the head, a center line of the chest, a center line of both arms or both feet (or both legs), or the like and may be replaced with any center line.

In addition, it is exemplified that the setting value is identified in conjunction with the joint separation arrangement in the above-mentioned description, but the present disclosure is not limited thereto. For example, the processor 250 of the computing device 200 may output a user interface capable of selecting the joint separation arrangement on a display 220 and may perform an operation according to the joint separation arrangement depending on a manager input. In this regard, the computing device 200 may further include an input device for the manager input.

When there is no the request for the joint separation arrangement in operation 1107, in operation 1111, the processor 250 may generate a virtual joint image based on all the joints. For example, the processor 250 may generate the virtual joint image depending on at least one of the methods for generating the virtual joint image, which are described above with reference to FIGS. 5 to 8. As an example, the processor 250 may generate a virtual joint image where coordinate values of a plurality of axes and joint prediction values are divided for each channel for the plurality of joints respectively corresponding to a plurality of frames, which are generated by applying the plurality of frames to a joint generation network, and may output the generated virtual joint image on the display 220.

In operation 1113, the processor 250 may identify whether an event associated with ending the generation of the virtual joint image occurs. When the event occurs, the processor 250 may end the generation of the virtual joint image. Meanwhile, when the event does not occur, in operation 1115, the processor 250 may perform a specified function. For example, the processor 250 may analyze the virtual joint image and may perform motion recognition. In this process, the processor 250 may perform motion recognition for the virtual joint image using a learning model for motion recognition (e.g., a lightweight artificial intelligence learning model or a 2D CNN) and may output the result on the display 220 or may match, store, and manage at least one of the image used for the virtual joint image, the virtual joint image, or the result of performing the motion recognition in a memory 240. In this operation, the processor 250 may input a title according to the motion recognition depending on a manager input and a predetermined certain rule. In addition, the processor 250 may provide a robot 400 with information associated with the motion recognition depending on the manager input.

Meanwhile, the case where the number of joints is 16 is described as an example in the above description, but it is possible to change the number of used joints. In this regard, when operating the joint generation network or generating the virtual joint image, the processor 250 may support a routine capable of specifying the number of joints to be applied (e.g., a scheme which provides a user interface and specifying the number of joints depending on a manager input). Furthermore, the processor 250 may assist in changing an order of channels corresponding to coordinates associated with the virtual joint image and the joint prediction value. For example, the processor 250 may change an order of data arrangement, for example, an order of (x, y, joint prediction value), (y, joint prediction value, x), (joint prediction value, x, y), . . . (x, y, z, joint prediction value), (z, x, y, joint prediction value), and the like depending on the manager input. In this regard, the processor 250 may provide a user interface capable of changing a joint arrangement order and may change the joint arrangement order depending on a manager input which is input through the input device connected with the computing device 200. As an example, for the virtual joint image presented in FIG. 10, the processor 250 may change data arrangement of “a left upper body, a right upper body, a left lower body, and a right lower body” (an order from a top row to a lower row) to an order of “the left upper body, the left lower body, the right upper body, and the right lower body” (an order from a top row to a lower row).

The processor 250 may provide various normalization schemes for a joint location value and a joint prediction value. For example, the processor 250 may provide a value of [0, 1], [−1, 1], or the like as a probability value for the joint prediction value. Furthermore, the processor 250 may provide various normalization values, such as [0, 1] or [−1, 1], depending on a manager input for the joint location value.

In a process of generating a joint change according to a frame in the form of an image and recognizing a video image to recognize motion, the present disclosure described above may achieve high performance with a 2D convolutional neural network (CNN) with low amount of calculation. As compared with the case where only the joint location value is used, the computing device 200 of the present disclosure may present an average performance improvement of 6% to 8%, as shown in Table 1 below.

TABLE 1

| | Recognition |
|---|---|
| Virtual joint structure | accuracy |
| (x location coordinate, y location coordinate)- | 0.9055 |
| prior paper structure | |
| (x location coordinate, y location coordinate, | 0.9611 |
| joint prediction value)<method 1, FIG. 5> | |
| (x location coordinate, y location coordinate, | 0.9777 |
| joint prediction value)<method 2, FIG. 6> | |
| (x location coordinate, y location coordinate, | 0.9834 |
| joint prediction value)<method 3, FIG. 7 + FIG. 8> | |

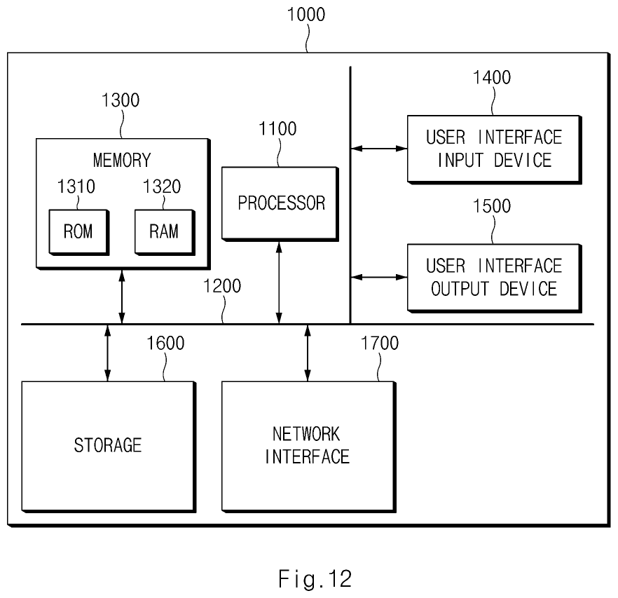

As compared with the case where the joint image is generated to correspond to the body of the person described above with reference to FIG. 4, the computing device 200 of the present disclosure may map one piece of joint information to one pixel through the virtual joint image, thus assisting in generating an image of a small size without a free space. Thus, because the computing device 200 of the present disclosure is able to generate the image of the small size, it may directly train a lightweight model. Thus, the computing device 200 of the present disclosure may be easily used even for a robot with low computing performance and may provide real time with a low amount of calculation. A variety of calculation associated with the motion recognition of the person described above with reference to FIGS. 3 to 11 may be performed by means of the above-mentioned computing device 200 of FIG. 2 or at least some of components of a computing system of FIG. 12, which will be described below. FIG. 12 is a block diagram illustrating a computing system.

Referring to FIG. 12, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure may generate a virtual joint image using a joint location value and a joint prediction value and may identify a correlation between joints using joint arrangement according to a body part of the person and a lightweight artificial intelligence learning model, thus assisting in more efficiently performing motion recognition of the person for the robot.

In addition, various effects ascertained directly or indirectly through the present disclosure may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the example embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A computing device comprising:
memory configured to store an image composed of a plurality of frames where a person is captured as a subject; and
a processor operatively connected with the memory,
wherein the processor is configured to:
determine a plurality of joints corresponding to the image;
determine joint data comprising:
joint prediction values for predicting whether the plurality of joints correspond to any of a plurality of known joints of the person, and
joint location values corresponding to locations of the plurality of joints;
generate, based on the joint data, a virtual joint image comprising coordinate values that correspond to the joint location values, wherein the coordinate values, in the virtual joint image, are divided into a plurality of channels; and
store the generated virtual joint image in the memory.

2. The computing device of claim 1, wherein the memory stores a joint generation learning model provided to determine the plurality of joints corresponding to the image, and
wherein the processor is further configured to:
apply the joint generation learning model to the image to determine, based on the plurality of frames, the plurality of joints; and
determine the joint data based on the plurality of joints.

3. The computing device of claim 2, wherein the processor is further configured to:
determine, based on the plurality of joints, a plurality of axial coordinate values for the plurality of joints in each of the plurality of frames and the joint prediction values corresponding to the plurality of axial coordinate values.

4. The computing device of claim 3, wherein the processor is further configured to:
obtain, based on the plurality of frames, the plurality of axial coordinate values and the joint prediction values;
accumulate the obtained coordinate values and the joint prediction values to generate a representative value; and
generate the virtual joint image based on the representative value.

5. The computing device of claim 1, wherein the processor is configured to generate the virtual joint image by:
dividing the joint location values and the joint prediction values based on a location for each body part of the person; and
arranging the divided joint location values and joint prediction values at different locations on a data arrangement diagram.

6. The computing device of claim 1, wherein the processor is configured to generate the virtual joint image by:
dividing the joint location values and the joint prediction values into at least one of:
an upper body portion and a lower body portion of the person, or
a left body portion and a right body portion of the person with respect to a center line of the person.

7. The computing device of claim 1, wherein the processor is further configured to:
recognize a motion of the person on the image based on the virtual joint image;
map a result of recognizing the motion with the image; and
store the mapped result in the memory.

8. The computing device of claim 1, further comprising at least one of:
a communication interface configured to receive the image from an external electronic device;
a camera device configured to capture the image of the person as the subject; or
a display configured to output the virtual joint image.

9. A method comprising:
obtaining, by a processor of a computing device, an image comprising a plurality of frames, in which a person is captured as a subject;
determining, by the processor, a plurality of joints corresponding to the image;
determining, by the processor, joint data comprising:
joint prediction values for predicting whether the plurality of joints correspond to any of a plurality of known joints of the person, and
joint location values corresponding to locations of the plurality of joints;
generating, by the processor and based on the joint data, a virtual joint image comprising coordinate values that correspond to the joint location values, wherein the coordinate values, in the virtual joint image, are divided into a plurality of channels; and
storing, by the processor, the generated virtual joint image in memory of the computing device.

10. The method of claim 9, wherein the determining of the plurality of joints comprises:
applying a joint generation learning model, previously stored in the memory, to the image to determine, based on the plurality of frames, the plurality of joints.

11. The method of claim 10, wherein the determining of the joint data comprises:
determining, by the processor and based on the plurality of joints, a plurality of axial coordinate values for the plurality of joints in each of the plurality of frames and the joint prediction values corresponding to the plurality of axial coordinate values.

12. The method of claim 11, wherein the generating of the virtual joint image comprises:
obtaining, by the processor and based on the plurality of frames, the plurality of axial coordinate values and the joint prediction values;
accumulating, by the processor, the obtained coordinate values and the joint prediction values to generate a representative value; and
generating the virtual joint image based on the representative value.

13. The method of claim 12, wherein the generating of the virtual joint image further comprises:
dividing, by the processor, the joint location values and the joint prediction values based on a location for each body part of the person; and
arranging, by the processor, the divided joint locations values and joint prediction values at different locations on a data arrangement diagram.

14. The method of claim 9, wherein the generating of the virtual joint image comprises:
dividing, by the processor, the joint location values and the joint prediction values into at least one of:
an upper body portion and a lower body portion of the person, or
a left body portion and a right body portion of the person with respect to a center line of the person.

15. The method of claim 9, further comprising:
recognizing, by the processor, a motion of the person on the image based on the virtual joint image;
mapping a result of recognizing the motion with the image; and
storing the mapped result in the memory.

16. A system comprising:
a robot;
an input data providing device configured to provide an image comprising a plurality of frames where a person is captured as a subject; and
a computing device,
wherein the robot is configured to receive, from the computing device, a result of determining the motion,
wherein the computing device comprises:
a communication interface configured to receive the image;
memory configured to store the image; and
a processor operatively connected with the communication interface and the memory, and
wherein the processor is configured to:
apply a joint generation learning model, previously stored in the memory, to the image to determine a plurality of joints of the person;
determine joint data comprising:
joint prediction values for predicting whether the plurality of joints correspond to any of a plurality of known joints of the person, and
joint location values corresponding to locations of the plurality of joints;
generate, based on the joint data, a virtual joint image comprising coordinate values that correspond to the joint location values, wherein the coordinate values, in the virtual joint image, are divided into a plurality of channels;
recognize a motion of the person on the image based on the generated virtual joint image; and
provide a result of recognizing the motion to the robot.
